(19) United States
(12) Patent Application Publication
(10) Pub. No.: US 2026/0080553 A1
(43) Pub. Date: Mar. 19, 2026

(54) THREE-DIMENSIONAL OBJECT SHAPE AND MOTION ESTIMATION FROM SPATIOTEMPORAL DATA WITH DIFFUSION GUIDED MODELS

(71) Applicant: Rutgers, The State University of New Jersey, New Brunswick, NJ (US)

(72) Inventors: Dimitris N. Metaxas, Princeton, NJ (US); Anastasios Stathopoulos, Highland Park, NJ (US)

(21) Appl. No.: 19/330,509

(22) Filed: Sep. 16, 2025

Related U.S. Application Data
(60) Provisional application No. 63/695,046, filed on Sep. 16, 2024.

(51) Int. Cl. G06T 7/50; G06N 3/0464; G06N 3/0475; G06T 5/70; G06T 7/70; G06V 10/44

(52) U.S. Cl. CPC G06T 7/50; G06N 3/0464; G06N 3/0475; G06T 5/70; G06T 7/70; G06V 10/44; G06T 2207/20182

(57) ABSTRACT

Systems, methods, and apparatuses for estimating a three-dimensional (3D) object. One apparatus includes at least one electronic processor and at least one memory storing a machine learning model and instructions executable by the at least one electronic processor. The machine learning model trained to receive an initial estimate of a set of model parameters corresponding to the 3D object and generated using a regression model, based on an input image, perform denoising diffusion implicit model (DDIM) inversion on the initial estimate to obtain a latent representation, generate, using a diffusion model and a score guidance term, a refined latent representation by iteratively applying a guided sampling process, and generate a refined estimate of the set of model parameters based on the refined latent representation.

### RELATED APPLICATIONS

This application claims priority to U.S. Provisional Patent Application No. 63/695,046, filed Sep. 16, 2024, which is incorporated by reference herein in its entirety.

### FEDERALLY SPONSORED RESEARCH

This invention was made with government support under grant numbers 2310966, 2235405, 2212301, 2003874 awarded by the National Science Foundation and grant number FA9550-23-1-0417 awarded by the United Stated Air Force Office of Scientific Research. The government has certain rights in the invention.

### SUMMARY

Three-dimensional (3D) human mesh recovery from two-dimensional (2D) images is a challenging task in computer vision with applications in augmented reality, motion capture, and human-computer interaction. Traditional approaches may be divided into two categories: regression-based methods that directly estimate model parameters from images, and optimization-based methods that iteratively refine an initial estimate to match image observations. While regression methods are fast, they often lack accuracy in detail. Optimization methods can achieve higher accuracy but are computationally expensive and sensitive to initialization. Recent advancements in generative models, particularly diffusion models, have shown promise in capturing complex data distributions, but their application to 3D human mesh recovery has been limited.

In addition, traditional methods estimate parameters (e.g., skinned multi-person linear (SMPL) parameters) for recovering the 3D human pose and shape from 2D evidence by optimizing handcrafted objectives, fitting the model to 2D data. These approaches, however, are slow, sensitive to initialization, and prone to local minima. To overcome these issues, regression-based methods use neural networks to directly predict parameters (e.g., SMPL parameters) from images. However, these feed-forward models often struggle to achieve both accurate 3D reconstruction and precise alignment with the input image, especially in monocular settings.

A hybrid approach combines regression with optimization where the regression network provides an initial estimate and optimization refines the initial estimate using additional observations. However, even this combined method faces challenges related to difficult and unstable optimization and requires multiple prior terms to produce meaningful results.

Examples described herein (also referred to as Score-Guided Human Mesh Recovery (ScoreHMR) address these and other technological issues by leveraging diffusion models to solve inverse problems related to Human Mesh Recovery (HMR). Score-Guided Human Mesh Recovery (ScoreHMR), as described herein, refines initial, per-frame 3D estimates obtained from regression networks based on additional observations. This approach uses a diffusion model as a learned prior of human body model (e.g., SMPL) parameters and guides its denoising process with a guidance term that aligns the human model with the available observation. The diffusion model, task-agnostic in nature, is trained on the generic task of capturing the distribution of plausible model parameters (e.g., SMPL parameters) conditioned on an input image. Given an initial regression estimate, the initial regression estimate is inverted to the corresponding latent of the diffusion model through inversion (e.g., through denoising diffusion implicit model (DDIM) inversion). Then deterministic model (e.g., DDIM) sampling is performed with a guidance term, where this guidance term acts as the data term in a standard optimization setting, and the diffusion model serves as a learned parametric prior. The model inversion and model guided sampling loop iterates until the body model aligns with the available observation. Accordingly, ScoreAMR performs a data-driven iterative fitting approach, achieving alignment with image observations through score guidance in the latent space of the diffusion model.

Thus, aspects of the present disclosure provide an approach to 3D human pose and shape reconstruction that bridges the gap between regression and optimization methods. Aspects of the present disclosure leverage a pre-trained diffusion model to capture the distribution of human body parameters conditioned on input images. A score guidance during the diffusion model's denoising process is utilized to refine the diffusion model's predictions. An initial estimate is refined effectively without requiring per-task training of the diffusion model. Aspects of the present disclosure provide superior performance across various applications, including keypoints model fitting, multi-view reconstruction, and human motion refinement in video sequences, consistently outperforming existing optimization baselines on popular benchmarks.

One example described herein provides a method for estimating a three-dimensional (3D) object, comprising: generating, using a regression model, an initial estimate of a set of model parameters corresponding to the 3D object based on an input image; performing, using a machine learning model, denoising diffusion implicit model (DDIM) inversion on the initial estimate to obtain a latent representation; generating, using a diffusion model and a score guidance term, a refined latent representation by iteratively applying a guided sampling process; and generating, using the machine learning model, a refined estimate of the set of model parameters based on the refined latent representation. In one aspect, generating the initial estimate comprises: extracting image features from the input image using a convolutional neural network (CNN) backbone (340); and predicting human body model parameters using a regression model, based on the extracted image features. In another aspect, performing DDIM inversion comprises: mapping the initial estimate to a latent space of the diffusion model at a predetermined noise level, using a deterministic inversion process. In another aspect, generating the refined latent representation comprises: calculating a modified noise prediction at each iteration, by combining a noise prediction from the diffusion model with the score guidance term; and updating the latent representation using the modified noise prediction, based on DDIM sampling equations. In another aspect, the score guidance term is based on keypoints from the input image. In another aspect, the score guidance term is based on additional views, wherein the additional views and the input image are different views of the 3D object. In another aspect, the score guidance term is based on additional frames, wherein the additional frames and the input image are different frames from a video.

Another example described herein provides a system for estimating a three-dimensional (3D) object, comprising: a processor; a memory storing instructions executable by the processor; and a machine learning model comprising parameters stored in the memory and trained to: generate, using a regression model, an initial estimate of a set of model parameters corresponding to the 3D object, based on an input image; perform denoising diffusion implicit model (DDIM) inversion on the initial estimate to obtain a latent representation; generate, using a diffusion model and a score guidance term, a refined latent representation by iteratively applying a guided sampling process; and generate a refined estimate of the set of model parameters based on the refined latent representation. In one aspect, the system further comprises: a convolutional neural network (CNN) backbone trained to extract image features from a 2D image; and a regression model trained to predict human body model parameters based on the extracted image features. In another aspect, the machine learning model is further trained to: map the initial estimate to a latent space of the diffusion model at a predetermined noise level, using a deterministic inversion process. In another aspect, the machine learning model is further trained to: calculate a modified noise prediction at each iteration, by combining a noise prediction from the diffusion model with the score guidance term; and update the latent representation using the modified noise prediction, based on DDIM sampling equations. In another aspect, the score guidance term is based on detected 2D keypoints from the input image. In another aspect, the score guidance term is based on additional views, and wherein the additional views and the input image are different views of the 3D object. In another aspect, the score guidance term is based on additional frames, and wherein the additional frames and the input image are different frames from a video.

Another example described herein provides a method for training a diffusion model for three-dimensional (3D) object estimate, comprising: obtaining a dataset of images and corresponding human body model parameters; predicting a noise using the diffusion model based on noisy human body model parameters and image features; computing a denoising loss based on a difference between the predicted noise and ground-truth noise added during a forward diffusion process; and updating parameters of the diffusion model based on the denoising loss. In one aspect, the method further comprises extracting image features from the images using a convolutional neural network (CNN) backbone; computing a feature extraction loss based on a difference between the extracted image features and ground-truth body model parameters; and updating parameters of the CNN backbone based on the feature extraction loss.

In another aspect, the method further comprises: predicting 2D keypoints from the human body model parameters; computing a reprojection loss based on a difference between the predicted 2D keypoints and ground-truth 2D keypoints; and updating parameters of the diffusion model based on the reprojection loss. In another aspect, the method further comprises: predicting pose parameters for multiple views using the diffusion model; computing a multi-view consistency loss based on differences between pose parameters predicted for different views of a same object; and updating parameters of the diffusion model based on the multi-view consistency loss. In another aspect, the method further comprises: predicting pose parameters for consecutive frames in a video; computing a temporal consistency loss based on differences between pose parameters of the consecutive frames; and updating parameters of the diffusion model based on the temporal consistency loss. In another aspect, the method further comprises: predicting body shape parameters using the diffusion model; computing a shape loss based on a difference between the predicted body shape parameters and ground-truth body shape parameters; and updating parameters of the diffusion model based on the shape loss.

Accordingly, examples described herein address inverse problems in 3D human recovery in various applications, including, for example, monocular images, multi-view images, and video frames as input. As described herein the methods and system surpasses existing optimization approaches across different datasets and evaluation settings without relying on task-specific designs or training. Beyond achieving superior results, ScoreAMR enhances the 3D pose performance of traditional monocular feed-forward system in the single-frame model fitting setting.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 schematically illustrates a real-time data analytics apparatus according to some examples.

FIG. 2 is a flow chart of a method for estimating an 3D object according to some examples.

FIG. 3 schematically illustrates a refinement process in combination with a monocular regression approach according to some examples.

FIG. 4 schematically illustrates an example of Score-Guided Human Mesh Recovery and applications according to some examples.

FIG. 5 illustrates an example qualitative evaluation of various recovery approaches against the Score-Guided Human Mesh Recovery according to some examples.

FIG. 6 illustrates an example qualitative evaluation of body model fitting results according to some examples.

FIG. 7 illustrates an example denoising model architecture according to some examples.

FIG. 8 illustrates an example qualitative evaluation of model fitting results according to some examples.

FIG. 9 illustrates failure cases of model fitting according to some examples.

FIG. 10 illustrates an example of multi-view refinement according to some examples.

### DETAILED DESCRIPTION

One or more examples are described and illustrated in the following description and accompanying drawings. These examples are not limited to the specific details provided herein and may be modified in various ways. Furthermore, other examples may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Furthermore, some examples described herein may include one or more electronic processors configured to perform the described functionality by executing instructions stored in non-transitory, computer-readable medium (e.g., to perform the computer-implemented methods described herein). Similarly, examples described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer readable medium may include, for example, a hard disk, a CD-ROM, an optical storage device, a magnetic storage device, a ROM (Read Only Memory), a RAM (Random Access Memory), register memory, a processor cache, or any combination thereof.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware and/or hardware. For example, as noted above, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms, such as, for example, first and second, top and bottom, and the like may be used herein solely to distinguish one entity or action from another entity or action without necessarily requiring or implying any actual such relationship or order between such entities or actions.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

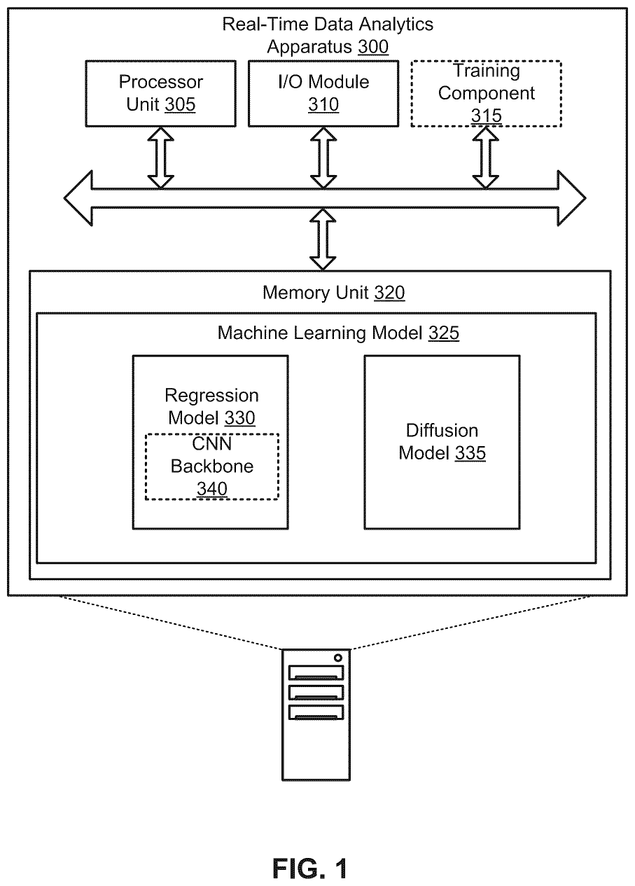

FIG. 1 schematically illustrates a real-time data analytics apparatus 300 according to some examples. In the particular example illustrated, the real-time data analytics apparatus 300 includes, among other things, an electronic processor unit 305, an I/O module 310, a training component 315, and a memory unit 320. The processor unit 305, the I/O module 310, the training component 315, and the memory unit 320 communicate over one or more control and/or data buses (e.g., an apparatus communication bus). FIG. 1 illustrates only one example of the real-time data analytics apparatus 300, and the real-time data analytics apparatus 300 may include more or fewer components than illustrated and may perform additional functions other than those described herein. For example, the apparatus 300 may include more than one processor unit 305, more than one I/O module, more than one training components 315, more than one memory unit 320, or a combination thereof. Also, the functionality described herein as being performed via the components stored in the memory unit 320 may be combined and distributed in additional or fewer components, wherein a component may include a set of instructions (software) and/or data executable by the processor unit 305. It should also be understood that the functionality described herein as being performed via the apparatus 300 may be distributed among multiple devices.

As used herein, “real-time” refers to a system or process that responds and updates immediately or with minimal delay, typically within milliseconds or microseconds. This immediacy allows information to be accessed and acted upon almost instantaneously. As used herein, “real-time” also includes “near real-time,” which implies a slight but acceptable delay in data processing and response, such as within seconds or a few minutes. Accordingly, real-time can be contrasted with “batch processing” or “offline processing,” wherein data is collected, stored, and processed at a later time.

In some instances, the processor unit 305 is implemented as a microprocessor with separate memory, such as the memory unit 320. In other instances, the processor unit 305 may be implemented as a microcontroller (with memory unit 320 on the same chip). In other instances, the processor unit 305 may be implemented using multiple processors. In addition, the processor unit 305 may be implemented partially or entirely as, for example, a field-programmable gate array (FPGA), and application specific integrated circuit (ASIC), and the like and the memory unit 320 may not be needed or be modified accordingly. In the example illustrated, the memory unit 320 includes non-transitory, computer-readable memory that stores instructions that are received and executed by the processor unit 305 to carry out functionality of the apparatus 300 as described herein. The memory unit 320 may include, for example, a program storage area and a data storage area. The program storage area and the data storage area may include combinations of different types of memory, such as read-only memory and random-access memory.

The I/O module 310 may include one or more ports (e.g., for receiving one or more wired cables or connections), transceivers, transmitters, receivers, or a combination thereof for communication with one or more devices or networks external to the apparatus 300. The memory 320 may store instructions and/or data received and executed by the processor unit 305 to carry out the functionality described herein. For example, as illustrated in FIG. 1, in some examples, the memory unit 320 stores a machine learning model 325 that, when executed by the processor unit 305 performs the functionality described herein or a portion thereof. In some aspects, the machine learning model 325 includes a regression model 330 and a diffusion model 335.

The optional training component 315, which may be implemented as software stored in the memory unit 320 or stored in a separate memory unit of the apparatus 300, is configured to train the models and/or neural network included in the machine learning model 325 (e.g., the regression model 330 and/or the diffusion model 335). In particular, the training component 315 may be configured to initialize the models/networks, iteratively input training data (which may be stored in the training component 315 or elsewhere) to the models/networks, and adjust internal parameters (e.g., weights and biases) of the models/networks until the models/networks is considered trained or accurate (e.g., until a loss function is minimized). The training component 315 is illustrated as being optional as, in some examples, the models/networks included in the machine learning model 325 may be initially trained by a separate apparatus as the apparatus performing the real-time data analysis.

For example, the training component 315 may train the diffusion model 335 for three-dimensional (3D) object estimation. The training component 315 obtains a dataset of images and corresponding human body model parameters. In some instances, the training component 315 obtains the dataset of images and corresponding human body model parameters from the memory unit 320. In other instances, the training component 315 obtains the dataset of images and corresponding human body model parameters from a remote source via the I/O module 310.

As noted above, in some aspects, the machine learning model 325 comprises the regression model 330 and the diffusion model 335. The diffusion model 335 capture complex data distributions. For example, the diffusion model 335 learns the implicit prior of the underlying data distribution x by matching the gradient of the log density ∇ₓ log p (x), also known as the score function. This learned prior can be utilized when solving inverse problems that aim to recover x from the observations y by incorporating the gradient of the log likelihood ∇ₓ log p (x|y), also referred to herein as a score guidance term, during sampling/denoising. The denoising process in the diffusion model 335, characterized by its iterative nature, provides a data-driven substitute for the iterative minimization employed in optimization-based techniques. Furthermore, the diffusion model 335 can be used in many downstream applications without task-specific retraining. For instance, by incorporating guidance with a keypoint reprojection term, the diffusion model 335 aligns a human body model with 2D keypoint detections. Similarly, when multiple uncalibrated views of a person are available, the systems and methods described herein employ cross-view consistency guidance to recover a 3D human mesh that maintains consistency across all viewpoints. Furthermore, in the context of inferring human motion from a video sequence, temporal consistency guidance, and optionally keypoint reprojection guidance, refines per-frame regression estimates, resulting in temporally consistent human motions.

In some instances, the machine learning model 325 (e.g., the regression model 330) includes a convolutional neural network (CNN) backbone 340 configured to extract salient features from a 2D input image. For example, the machine learning model 325 provides a Score-Guided Human Mesh Recovery (ScoreHMR), which solves inverse problems for 3D human pose and shape reconstruction. These inverse problems involve fitting a human body model to image observations, traditionally solved through optimization techniques. In some aspects, the machine learning model 325 mimics model fitting approaches, but alignment with the image observation is achieved through score guidance in the latent space of the diffusion model 335. The diffusion model 335 is trained to capture the conditional distribution of the human model parameters given an input image. By guiding a denoising process with a task-specific score, the machine learning model 325 effectively solves inverse problems for various applications without the need for retraining the task-agnostic diffusion model 335. As described in greater detail herein, the machine learning model 325 may be used in various settings or application, such as, for example, (i) single-frame model fitting; (ii) reconstruction from multiple uncalibrated views; (iii) reconstructing humans in video sequences, and consistently outperforms optimization baselines on popular benchmarks across various settings.

In some aspects, the machine learning model 325 employs a two-step approach to generate human body model parameters when performing the initial estimation process. For example, first, the CNN backbone 340 extracts salient features from the 2D input image. These features capture initial information about the human pose and shape. Subsequently, the regression model 330 processes these extracted features to predict the initial human body model parameters. This approach may provide a strong starting point for the subsequent refinement process. In some aspects, the apparatus 300 receives, via the I/O module 310, the initial estimate from a remote device/system including a regression model.

In some aspects, the machine learning model 325 performs the DDIM inversion process and channels the initial estimate to a latent space of the diffusion model 335. For example, the DDIM inversion process employs a deterministic inversion process to map the initial human body model parameters to a latent representation at a predetermined noise level. In some examples, this step enables the machine learning model 325 to leverage the powerful priors learned by the diffusion model 335 while maintaining a connection to the specific input image.

In some aspects, the machine learning model 325 refines the latent representation through an iterative process that combines the pre-trained diffusion model 335 with task-specific guidance. For example, at each iteration, a modified noise prediction is calculated by augmenting a noise prediction of the diffusion model 335 with a score guidance term. The machine learning model 325 updates, using the modified prediction, the latent representation according to DDIM sampling equations described herein. According to some aspects, this approach allows for a guided exploration of the latent space, progressively improving the 3D object estimate, for example, the 3D human mesh estimate.

In some aspects, the machine learning model 325 incorporates a score guidance when calculating the modified noise prediction. The score guidance based on the alignment between the current estimate and the observed 2D keypoints from the input image. In some aspects, the machine learning model 325 refines the 3D human mesh estimate using 2D keypoint detections from a single image. The machine learning model 325 starts with an initial 3D mesh estimate and then iteratively adjusts the initial 3D mesh to align with the detected 2D keypoints. In some aspects, the score guidance is based on additional views of the same object. In these examples, the additional views of the same object are used as observations to guide the diffusion process. In some aspects, the score guidance is based on additional frames of a video, where the additional frame include the same object. In these examples, the frame views of the same object are used as observations to guide the diffusion process.

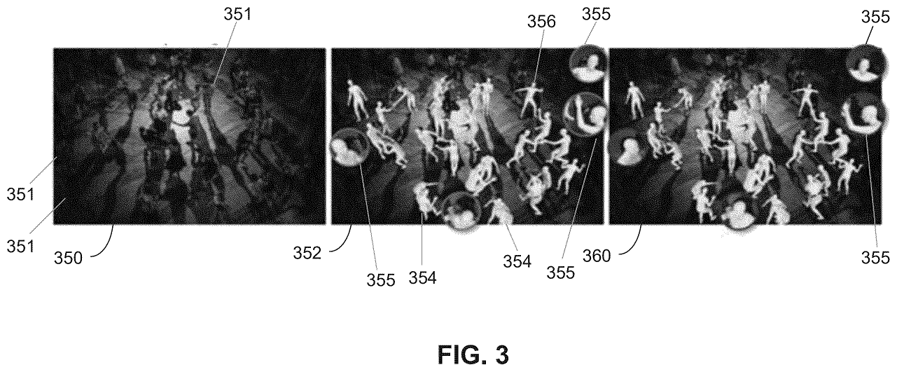

As described in greater detail herein, the machine learning model 325 estimates a three-dimensional (“3D”) object. Estimating the 3D object includes estimating a human mesh from a two-dimensional (“2D”) image. The machine learning model 325 uses a combination of the regression model 330 and the diffusion model 335 to estimate the 3D object. The machine learning model 325 obtains an input image and derives, using the regression model 330, an initial estimate of human body model parameters from the input image. The machine learning model 325 performs, using the diffusion model 335, a denoising diffusion implicit model (DDIM) inversion process on the initial estimate of human body model parameters, mapping the initial estimate to a latent representation. The machine learning model 325 refines the latent representation by iterative guided sampling, using a pre-trained diffusion model, for example, the diffusion model 335, and a score guidance term. The machine learning model 325 generates refined object model parameters that more accurately represent a 3D object based on the 2D input image. For example, FIG. 3 schematically illustrates the refinement process in combination with a monocular regression approach, according to some aspects. FIG. 3 includes three images. The first image 350 is a 2D input image (left image) including articulable objects (i.e., a plurality of human forms 351). The second image 352 illustrates the monocular regression approach encountering challenges in aligning the human body model (see white body models 354) to the human forms 351 of the second image. For example, as illustrated in magnified callouts 355 in the image 352, some of the body models 354 are misaligned with the human form 351 they are intended to represent. The machine learning model 325, as described herein, addresses the alignment challenges with an iterative refinement approach that utilizes image observations (e.g., 2D key point detections) and achieves better image-model alignment as shown in a third image 360 and the include magnified callouts 355 (right image).

Many approaches of regressions for human mesh recovery (HMR) simultaneously learn a representation for a 3D shape while learning to recover the 3D shape of articulated objects. However, for the human category, parametric models of the human body exist, and most approaches in this paradigm learn to regress their parameters. HMR uses multilayer perceptron (MLP) layers on top of image features from a CNN to regress the SMPL model parameters. Other approaches utilize a more specialized design for a CNN backbone and incorporate a mesh alignment module for SMPL parameter regression. Still other approaches learn distinct features for the pose and shape parameters of SMPL and introduce a body-part-guided attention mechanism to handle occlusions. Another approach may propose a fully “transformerized” version of HMR and can effectively reconstruct unusual poses that have been difficult for previous methods. Yet other approaches make nonparametric predictions by directly regressing the vertices of the SMPL model. The SMPL parameters can be regressed from non-parametric predictions with an MLP without any loss in reconstruction performance. These approaches, however, utilize iterative optimization to estimate the parameters of a human model where the objective is often formulated as an energy minimization problem by fitting a parametric model to the available observations and consists of data and prior terms. The data terms measure the deviation between the estimated and detected features, while the prior terms impose constraints on the model parameters. Parametric priors are important during optimization to obtain a meaningful solution. However, optimization suffers from many difficulties, including sensitivity to parameter initialization, the existence of multiple local minima and the trade-off between the data and prior terms. Regression methods often serve as an initial point for an optimization-based method, which refines the estimated parameters until a convergence criterion is met. This practice not only makes the optimization converge faster, but also typically results in a better solution since a lot of local minima are avoided. The need for multi-stage optimization procedures, as followed by early systems, is also alleviated since the regressed parameters are typically close to a good solution. Examples described refine an initial regression estimate, such as an initial estimate in the form of SMPL parameters generated by the regression model 330, using the diffusion model 335 to improve the alignment of the initial estimate.

With diffusion models, in particular the denoising diffusion probabilistic model (DDPM) formulation, let x₀˜p_{data}(x) denote samples from the data distribution. Diffusion models progressively perturb data to noise (i.e., a forward process) via Gaussian kernels for T timesteps, which creates latents

$${\{ {x}_{t} \}}_{t = 1}^{T} .$$

The noise is added with a predefined variance schedule

$${\{ {ζ}_{t} \}}_{t = 1}^{T} ,$$

such that a standard Gaussian distribution is obtained when t=T, i.e., x_{T}˜ [symbol] (0, I). Latents xₜ can be directly sampled from a data point x₀ as q(xₜ|x₀)=N(\sqrt{αₜx₀}, (1−αₜ)I, where

$${α}_{t} := {\prod }_{s = 1}^{t} ( 1 - {ζ}_{s} ) .$$

A denoising ϵ_{φ} model is trained to predict the added noise to a clean sample via minimization of the following re-weighted evidence lower bound:

$${ℒ}_{s i m p l e} ( ϕ ) = {E}_{{x}_{0 , t , ε}} {‖ {∈}_{ϕ} ( {x}_{t} , t ) - ϵ ‖}^{2} \qquad ( 1 )$$

where t is sampled uniformly from {1, . . . , T}, and noise ϵ is added to a clean sample x₀˜p_{data} to get a noisy sample xₜ. Once the denoising model ϵ_{φ} is learned, the model can be used to generate samples from the diffusion model by sampling x_{T}˜ [symbol] (0, I) and iteratively refining it with ϵ_{φ}. The predicted noise for a latent xₜ at timestep t (noise level) from the denoising model ϵ_{φ} is related to the score of the model at that timestep:

$${ϵ}_{ϕ} ( {x}_{t} , t ) = - \sqrt{1 - {α}_{t}} {∇}_{{x}_{t}} log p ( {x}_{t} ) \qquad ( 2 )$$

Since the sampling process (i.e., the reverse process) of the DDPM formulation is known to be slow, the machine learning model 325 may use a denoising diffusion implicit model (DDIM) formulation for the diffusion model 335, which defines the diffusion process as a non-Markovian process with the same forward marginals as DDPM. This enables faster sampling with the sampling steps given by:

$${x}_{t - 1} = \sqrt{{α}_{t - 1}} {\hat{x}}_{0} ( {x}_{t} ) + \sqrt{1 - {α}_{t - 1}} - {σ}_{t}^{2} {ϵ}_{ϕ} ( {x}_{t} , t ) + {σ}_{t} z \qquad ( 3 )$$

where z· [symbol] (0, I), σₜ is the variance of the noise used during sampling, and \hat{x}₀(xₜ) denotes the predicted x₀ from xₜ and is given by:

$${\hat{x}}_{0} ( {x}_{t} ) = \frac{1}{\sqrt{{α}_{t}}} ( {x}_{t} - \sqrt{{α}_{t} {ε}_{ϕ} ( {x}_{t} , t ) ,} ≃ \frac{1}{\sqrt{{α}_{t}}} ( {x}_{t} + 1 - {α}_{t} ) {∇}_{x} log p ( {x}_{t} ) \qquad ( 4 )$$

By setting σₜ to 0, the sampling process becomes deterministic and enables inversion of samples from p_{data} to their corresponding latents. The machine learning model 325 may use this same framework for modeling conditional distributions, such as by incorporating the conditional information in the forward and reverse processes.

SMPL is a parametric human body model and consists of pose θ∈ [symbol] ^{24×3} and shape β∈ [symbol] ¹⁰ parameters, and defines a mapping [symbol] (θ, β) from the human body parameters to a body mesh M∈ [symbol] ^{N×3}, where N=6980 is the number of mesh vertices. For a given output mesh M, the 3D body joints J can be computed as a linear combination of the mesh vertices J=WM, where W is a pre-trained linear regressor, such as the regression model 330.

Suppose observations y∈ [symbol] ⁿ relate to some unknown signal x₀ϵ [symbol] ^{m} through

$$y = ( {x}_{0} ) + η \qquad ( 5 )$$

where [symbol] (⋅) is a forward operator and η is the observation noise. The machine learning model 325 recovers x₀ from y to solve the inverse problem. Recovering the SMPL parameters x₀={θ₀, β₀} from observations y (e.g., 2D keypoint detections), from which the closed-form map to x₀ is intractable. Solutions to this family of problems are given through iterative optimization by minimization:

$$arg {min}_{{x}_{0}} = {ℒ}_{data} ( {x}_{0} ) + {ℒ}_{p r i o r} ( {x}_{0} ) \qquad ( 6 )$$

where [symbol] ₐₜa measures the deviation between the estimated and detected features and [symbol] consists of several prior terms necessary to obtain a plausible solution.

In some aspects, the machine learning model 325 obtains an input image I of a person and generates a corresponding SMPL estimate x_{reg}={θ_{reg}, β_{reg}} from regression using the regression model 330. The machine learning model 325 improves x_{reg} in the presence of additional observations y by injecting suitable information in the denoising process of the diffusion model 335 through the log likelihood score. For example, the regression model 330 provides an initial estimate x_{reg} for the SMPL parameters, while observations y are also automatically detected. Furthermore, the diffusion model 335, a trained diffusion model ϵ_{φ}(t, I), captures the conditional distribution of SMPL model parameters given an input image I.

The machine learning model 325 uses the regression estimate x_{reg} as an initial point, and inverts the regression estimate x_{reg} to the latent xₜ at noise level τ with the deterministic DDIM inversion process of the diffusion model 335:

$${x}_{t + 1} = \sqrt{{α}_{t - 1}} {\hat{x}}_{0} ( {x}_{t} ) + \sqrt{1 - {α}_{t + 1}} {ϵ}_{ϕ} ( {x}_{t} , t , I ) \qquad ( 7 )$$

Running the deterministic DDIM sampling starting from x_{z}, gets back the initial estimate x_{reg} with a reconstruction error is less than 10⁻³ per dimension, which suggests that the DDIM inversion and DDIM sampling loop works as intended. However, getting back the initial regression estimate is not of interest because the goal of the machine learning model 325 is improving the initial regression estimate based on the available observation y.

In some aspects, the machine learning model 325 uses the conditional score ∇ₓ_{ₜ} log p(xₜ|I,y) during DDIM sampling instead of the score ∇ₓ_{ₜ} log p(xₜ|I) of the data distribution. Using Bayes rule the score is written ∇ₓ_{ₜ} log p(xₜ|I,y)=∇ₓ_{ₜ} log p(xₜ|I)+∇ₓ_{ₜ} log p(y|I, xₜ), where the first term is the score of the diffusion model ϵ_{φ}(xₜ, t, I). However, one issue with this posterior sampling approach is that there does not exist an analytical formulation for the likelihood score ∇ₓ_{ₜ}, log p(y|I, xₜ). To resolve this, estimates of the likelihood are made under some assumptions. By assuming that the observation noise η in Eq. (5) is Gaussian, the following equation exists:

$${∇}_{{x}_{t}} log p ( y \vert I , {x}_{t} ) ≃ {∇}_{{x}_{t}} log p ( y \vert I , {\hat{x}}_{t} ( {x}_{t} ) ) = - ρ {∇}_{{x}_{t}} {‖ y - ( {\hat{x}}_{0} ( {x}_{t} ) ) ‖}_{2}^{2} \qquad ( 8 )$$

where ρ can be viewed as a tunable step size. Approximating the likelihood score with Eq. (8), guidance is applied to the deterministic DDIM sampling process, with the sampling equations below:

$${\hat{x}}_{0}^{′} ( {x}_{t} ) = \frac{1}{\sqrt{{α}_{t}}} ( {x}_{t} - \sqrt{{α}_{t} {ϵ}_{ϕ}^{′} ( {x}_{t} , t , I )} , \qquad ( 9 )$$

$${x}_{t - 1} = \sqrt{{α}_{t - 1}} {\hat{x}}_{0}^{′} ( {x}_{t} ) + \sqrt{1 - {α}_{t - 1}} {ϵ}_{ϕ}^{′} ( {x}_{t} , t , I )$$

where ϵ_{φ}′ is the modified noise prediction after guidance:

$${ϵ}_{ϕ}^{′} = {ϵ}_{ϕ} ( {x}_{t} , t , I ) + ρ \sqrt{1 -} {α}_{t} {∇}_{{x}_{t}} {‖ y - 𝒜 ( {\hat{x}}_{0} ( {x}_{t} ) ) ‖}_{2}^{2} \qquad ( 10 )$$

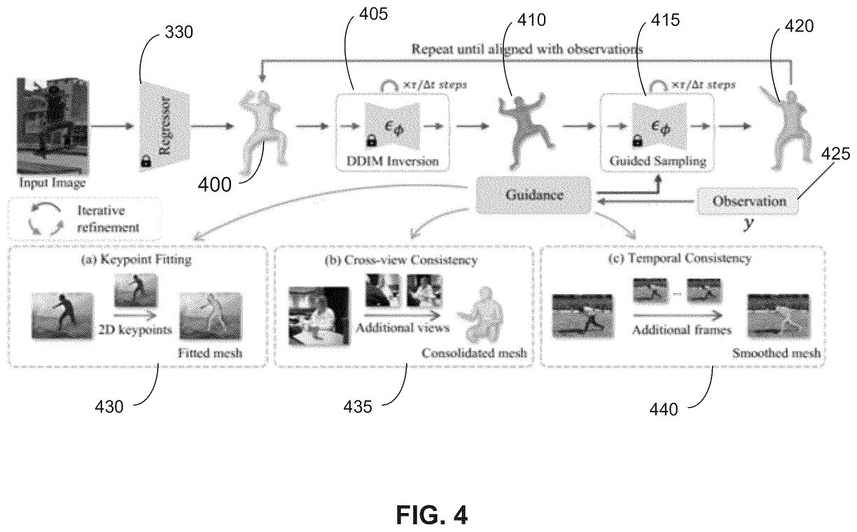

For example, FIG. 4 illustrates an example schematic of a Score-Guided Human Mesh Recovery flow as performed, for example, by the real-time data analytics apparatus 300. In this example, the ScoreHMR (e.g., the machine learning model 325) provides an input image into a regressor (e.g., the regression model 330), which generates an initial regression estimate 400. A DDIM inversion process 405 of a diffusion model (e.g., the diffusion model 335) maps the initial regression estimate 400 to a latent space of the diffusion model 335 at a predetermined noise level (i.e., mapped initial regression estimate 410). The diffusion model iteratively refines the mapped initial regression estimate 410 in a DDIM guided sampling loop 415 until the human body model 420 aligns with an available observation 425.

In some aspects, the ScoreAMR guides sampling (i.e., as part of the guided sampling loop 415) based on body model fitting to 2D keypoints 430, multi-view refinement of individual per-frame predictions with cross-view consistency guidance 435, or recovering temporally consistent and smooth 3D human motion from a video sequence given initial per-frame estimates 440. A visual summary of ScoreAMR using each of these guidance forms is provided in FIG. 4 and these guidance forms are further described below.

In some aspects, the DDIM inversion (Eq. (7)) is used followed by guided DDIM sampling (Eqs. (9) and (10)) in a loop, as shown in FIG. 4, aligning the human body model 420 with the detected observations 425. The loop stops when the relative change of the guidance loss

$${ℒ}_{g} = {‖ y - 𝒜 ( {\hat{x}}_{0} ( {x}_{t} ) ) ‖}_{2}^{2}$$

implementation of ScoreAMR is shown below as Algorithm 1.

Algorithm 1 Score-Guided Human Mesh Recovery (ScoreHMR)
Input: Given observation y, denoising model ϵ_{φ}, image features cₗ,
estimate x_{reg} from a regression network, gradient step size ρ,
noise level T, DDIM step size Δt, threshold λₜₕᵣₑₛ, number of iterations
for the outer refinement loop Smax.

| | |
|---|---|
| 1: for s = 1 to Sₘₐₓ do | |
| 2: if s = 1 then | |
| 3: xᵢₙᵢₜ ~ x_{reg} | [symbol] First iteration starts with |
| | estimate from regression |
| 4: else | |
| 5: xᵢₙᵢₜ ← x₀ | [symbol] Iteration starts with x₀ from |
| | previous iteration |
| 6: end if | |
| 7: x_{τ} = DDIMINvert(xᵢₙᵢₜ, cₗ) | [symbol] Run DDIM inversion until |
| | noise level T |
| 8: for t = T to Δt with step size Δt do | |
| 9: \tilde{ϵ} ← ϵ_{φ}(xₜ, t, cᵢ) | [symbol] Predict noise |
| 10: Initialize computational graph for xₜ | |
| 11: ${\hat{x}}_{0} ← \frac{1}{\sqrt{{α}_{t}}} ( {x}_{t} - \sqrt{1 - {α}_{t} )} \tilde{ϵ}$ | [symbol] Predict one-step denoised result |
| 12: [symbol] _{g} ← ∥y - [symbol] (\hat{x}₀)∥² | [symbol] Compute guidance loss |
| 13: if [symbol] _{g} > λₜₕᵣₑₛ then | |
| 14: return \hat{x}₀ | [symbol] Early stopping: return x₀ if |
| | the loss is below a threshold |
| 15: end if | |
| 16: \tilde{ϵ}′ ← \tilde{ϵ} + ρ{square root over (1-αₜ))}∇ₓ_{ₜ} [symbol] _{g} | [symbol] Compute modified noise |
| | after score-guidance |
| 17: ${\hat{x}}_{0} ← \frac{1}{\sqrt{{α}_{t}}} ( {x}_{t} - \sqrt{1 - {α}_{t} )} {\tilde{ϵ}}^{′}$ | [symbol] Predict one-step denoised result with modified noise |
| 18: x_{t-Δt} ← \sqrt{αₜ} - Δt\hat{x}_{₀}' + {square root over (1 - αₜ))}\tilde{ϵ}′ | [symbol] DDIM sampling step |
| 19: end for | |
| 20: end for | |
| 21: return x | |

### Model Design and Training

In some aspects, without loss of generality, the diffusion model 335 models the pose SMPL parameters, i.e., x₀=θ, to maintain a fair comparison with optimization methods utilizing a learned pose prior. In addition, the shape parameters β of SMPL can also be accommodated using the same approach with the diffusion model 335.

In some aspects, the machine learning model 325 given an input image I of a person, encodes with a CNN backbone g (e.g., CNN Backbone 340) and obtains a context feature c=g(I). The machine learning model 325 models the distribution of plausible poses for that person conditioned on I with a diffusion model (e.g., the diffusion model 335) ϵ_{φ}(xₜ, t, c=g(I)). In some instances, the backbone g is trained end-to-end with ϵ_{φ}. In other instances, the backbone g remains frozen while training the diffusion model. In the latter instance, the machine learning model 325 can use the features from the backbone of a regression network (e.g., the regression model 330).

### Architecture

In some aspects, the machine learning model 325 uses the 6D representation for 3D rotations, thus x₀ is a 144-dimensional vector. In some instances, the denoising model ϵ_{φ} is comprised of 3 MLP blocks that are conditioned on the timestep t and image features c. The model is given a noisy sample xₜ for the pose parameters, the timestep t and image features c as input. A linear layer to project xₜ to the features h⁽¹⁾ given as input to the first MLP block. The input features h⁽ⁱ⁾ϵ [symbol] ¹⁴⁴ of each MLP block are conditioned on the timestep t, by applying scaling and shifting to get the features

$${h}_{t}^{( i )} = {t}_{s} {h}^{( i )} + {t}_{b} ,$$

where (tₛ, t_{b}ϵ [symbol] ^{2×144}=MLP(ψ(t)) is the output of a MLP with a sinusoidal encoding function ψ. Then, each MLP block is conditioned on the image features by concatenating

$${h}_{t}^{( i )}$$

and c.

### Denoising Model Architecture

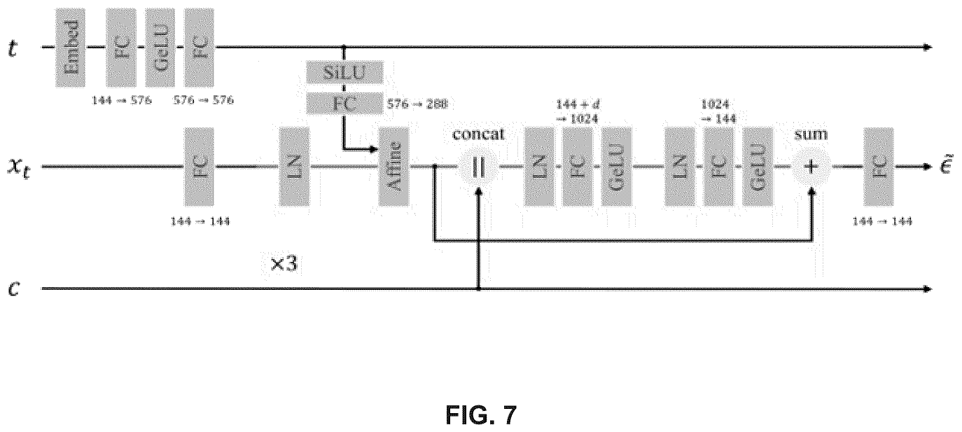

The architecture of the denoising model ϵ_{φ}, according to some aspects, is depicted in FIG. 7, where the model may be an implementation of ϵ_{φ}(xₜ, t, c)=g(I). In FIG. 7, LN denotes Layer Normalization, II denotes concatenation, and d denotes the dimension of the image features c. Rotations are parameterized with 6D representations, thus x₀, xₜ, \tilde{ϵ} are 144-D vectors. For each trainable layer, the number of input and output features are included as dᵢₙ→dₒᵤₜ. The image features c are used from frozen regression networks as discussed herein. The regression networks may use a standard ResNet-50 backbone, and the features are used after the global average pooling layer, i.e., the dimension of c is 2048. In some aspects, the denoising model uses the pose features of a part attention regressor, therefore, c is a 3072-dimensional vector.

### Training

In some aspects, the diffusion model 335 is trained with a collection of images paired with SMPL pose annotations and standard training loss:

$${ℒ}_{DM} ( ϕ ) = {𝔼}_{( I , {x}_{0} ) , t , ϵ} {‖ {ϵ}_{ϕ} ( {x}_{t} , t , I ) - ϵ ‖}^{2} \qquad ( 11 )$$

In some instances, such paired annotations are not generally available. In those instances, the diffusion model 335 is trained with pseudo ground-truth SMPL pose annotations from various datasets. The datasets used for training may include, for example, Human3.6M, MPI-INF-3DHP, COCO, and MPII. The datasets used for evaluation may include, for example, 3DPW, EMDB, Human3.6M, and Mannequin Challenge. Human3.6M includes data for 3D human pose captured in a studio environment. A first subset of data (e.g., subjects S1, S5, S6, S7 and S8) are used for training, while a second subset of data (e.g., subjects S9 and S11) are used for evaluation in the multi-view refinement setting. MPI-INF-3DHP includes data for 3D human pose captured mainly in indoor studio environments with a markerless setup. A predefined train split of the data is used for training. COCO includes images in-the-wild annotated with 2D keypoints. MPII includes images annotated with 2D keypoints. In some aspects, COCO and MPII are only used during training. 3DPW includes a dataset captured in indoor and outdoor locations and contains SMPL pose and shape ground-truth. EMDB includes a dataset captured in indoor and outdoor locations and contains SMPL pose and shape ground-truth. The data set also includes a split (i.e., EMDB 1) with the most challenging outdoor sequences, which are used for evaluation. Mannequin Challenge includes videos of people staying frozen in various poses. The SMPL annotations are used for evaluation in this dataset.

The apparatus 300 can use the datasets, such as, for example Human3.6M, MPI-INF-3DHP, COCO, and MPII for training. In some aspects, the training component 315 uses the datasets for training the diffusion model 335 of the machine learning model 325. The quality of the pseudo ground-truth pose annotations impact the training the diffusion model 335. In some instances, the total number of timesteps in the diffusion model 335 is set to T=1,000. The diffusion model 335 may be trained using a cosine variance schedule. In these instances, the diffusion model 335 is trained with a batch size of 128, a learning rate 10⁻⁴, and Adam optimizer for 1M iterations. An exponential moving average (EMA) copy of the model with a rate of 0.995 is maintained. Additionally, training may be performed over approximately 6 hours on a single NVIDIA A100 GPU. However, other training environments may be used.

Furthermore, in some aspects, the gradient step size in Eq. (8) is set to ρᵣₑₚᵣ=0.003, μMV=0.005 and ρₜₑₘₚ=30 for [symbol] ᵣₑₚᵣ, [symbol] _{MV} and [symbol] ₜₑₘₚ respectively. Also, the outer refinement loop may be set to Sₘₐₓ=10, the threshold for the early stopping criterion may be set to λₜₕᵣ=105, the timestep (noise level) where the refinement process starts may be set to τ=50, and the DDIM step size may be set to Δt=2. For multi-view refinement experiments, τ may be set to 100 and Δt may be set to 10.

### Applications of ScoreHMR

Aspects of the present disclosure described herein provide an approach for solving HMR-related inverse problems with various applications using the same trained diffusion model with no per-task training. Various settings for such applications are described below.

### Body Model Fitting (e.g., Keypoint Fitting)

In this setting the detected image observations are 2D keypoints detections yₖₚ and their confidences y_{conf}. Optimization approaches fit the SMPL body model to the 2D keypoints by minimizing λⱼE_{J}+λₚᵣᵢₒᵣEₚᵣᵢₒᵣ, where E_{J} penalizes the deviations between the projected model joints and the detected joints and Eₚᵣᵢₒᵣ include prior energy terms for the pose and shape parameters of SMPL.

Typically, the predicted weak-perspective camera from a regression network is converted to a perspective camera π=(R, γ) based on the bounding box of a person and is also included as a variable to be optimized. The camera w has fixed focal length and intrinsics K. Since the parameters θ already include a global orientation, Rϵ [symbol] ^{3×3} is assumed to be identity and only the camera translation γϵ [symbol] ³ is optimized along with the human body model parameters.

In this setting, the forward operator that relates the body model parameters with the detected joints is Π_{K}(W [symbol] (x₀, β)+γ), where Π_{K} is the projection matrix with camera intrinsics K and W is a matrix that regresses the 3D model joints from the mesh vertices of the model. This means that the guidance loss in Eq. (10) becomes:

$${ℒ}_{repr} = {y}_{conf} {‖ {Π}_{K} ( W ℳ ( {\hat{x}}_{0} ( {x}_{t} ) , β ) + γ ) - {y}_{k p} ‖}_{2}^{2} \qquad ( 12 )$$

The camera translation γ is also optimized with [symbol] ᵣₑₚᵣ as in standard optimization procedures.

### Multi-View Refinement (e.g., Cross-View Consistency)

In this setting, a set

$${\{ {I}^{( n )} \}}_{n = 1}^{N}$$

of uncalibrated views of the same person are available, and their monocular regression estimate are improved based on information from the other views. For each frame, the pose parameters

$${x}_{0}^{( n )}$$

are decomposed to global orientation

$${x}_{0 , gl}^{( n )}$$

and body pose parameters

$${x}_{0 , b}^{( n )} .$$

All single-frame predictions can be consolidated to improve

$${x}_{0 , b}^{( n )}$$

with a cross-view consistency guidance loss:

$${ℒ}_{M V} = {\sum }_{n = 1}^{N} {‖ {\hat{x}}_{0 , b}^{( n )} ( {x}_{t}^{( n )} ) - {\overline{x}}_{0 , b} ‖}_{2}^{2} \qquad ( 13 )$$

where

$${\overline{x}}_{0 , b} - \frac{1}{N} {\sum }_{n}^{N} {x}_{0 , b}^{( n )} ( {x}_{t}^{( n )} )$$

and its minimization is equivalent to minimizing the squared distance between all pairs of body poses.

### Human Motion Refinement (e.g., Temporal Consistency)

Although the diffusion model 335 has been trained in the monocular setting, learned conditional distribution can be used to obtain temporally consistent and smooth predictions in a video sequence

$$V = {\{ {I}^{( n )} \}}_{n = 1}^{N} .$$

In this setting, the forward operator is the identity function and the observations are the pose predictions of the previous frame in the sequence. Therefore, temporal consistency can be enforced with the following guidance loss:

$${ℒ}_{temp} = {\sum }_{n = 1}^{N} {‖ {\hat{x}}_{0}^{( n )} ( {x}^{t} ) - {\hat{x}}_{0}^{n - 1} ( {x}_{t} ) ‖}_{2}^{2} \qquad ( 14 )$$

Guidance with the previous loss can be considered as a learnable smoothing operation that makes sure that the smoothed parameters remain consistent with the image evidence under the image-conditional distribution captured by the diffusion model 335. In addition, or alternatively, additional guidance can be used with the keypoint reprojection loss in Eq. (12) when 2D keypoint detections are available.

### Evaluation Datasets

As set forth herein, ScoreHMR, as described herein, outperforms other modeling techniques based on various evaluations performed using the evaluation datasets and benchmarks as described below. For example, body model fitting to 2D keypoints and human motion refinement settings can be evaluated on the test set of 3DPW and on the split of EMDB that contains the most challenging sequences (i.e., EMDB 1). The multi-view refinement experiment can be evaluated on Human3.6M and Mannequin Challenge. The Mannequin Challenge can use the annotations produced by Leroy et al. and employ the entire dataset for evaluation.

### Evaluation Setup

To demonstrate the efficacy of the score guidance approach, as described herein, in refining the regression estimates from various networks and accuracy levels, predictions from ProHMR's regression network and HMR 2.0 were used as starting points. For experiments with HMR 2.0, the HMR 2.0b model, which trains longer and, on more data, than HMR 2.0a, was used.

### Quantitative Evaluation

### Body Model Fitting

The accuracy of methods that fit the SMPL body model to 2D keypoint detections were evaluated as set forth below in Tables 1 and 2. In this evaluation, the keypoints were detected with an open-source library for real-time, multi-person, 2D pose estimation (e.g., OpenPose).

### Ablation Study

As described herein, an ablation study of the components of ScoreHMR was provided. ScoreHMR was benchmarked with diffusion models trained with frozen image features from ProHMR and PARE, and pseudo groundtruth pose annotations from SPIN and EFT. The results of iterative refinement with ScoreHMR using the keypoint reprojection loss [symbol] ᵣₑₚᵣ in Eq. (12) are reported below. Following the typical protocols. the PA-MPJPE metric for evaluation was used and results are presented in Table 1. From Table 1, running ScoreHMR on top of regression reduces the 3D pose errors in all cases. The iterative refinement with ScoreHMR is robust to the choice of image features and pseudo groundtruth. The diffusion model 335, trained with PARE image features and fits from EFT, attains the highest performance. This study combined ScoreHMR with ProHMR features and SPIN fits as well as with PARE features and EFT fits), denoting them herein as ScoreHMR-a and ScoreHMR-b, respectively.

TABLE 1
Ablation study. ScoreHMR is initialized by the corresponding
regression results. All numbers are PA-MPJPE in mm. Parenthesis
denotes the number of body joints used to compute PA-MPJPE.

| | Features | Fits | 3DPW (14) | EMDB 1 (24) |
|---|---|---|---|---|
| ProHMR | — | — | 59.8 | 86.1 |
| +ScoreHMR | ProHMR | SPIN | 55.7 | 77.8 |
| +ScoreHMR | ProHMR | EFT | 55.5 | 77.4 |
| +ScoreHMR | PARE | SPIN | 55.6 | 77.4 |
| +ScoreHMR | PARE | EFT | 54.7 | 77.1 |
| HMR 2.0 | — | — | 54.3 | 78.7 |
| +ScoreHMR | ProHMR | SPIN | 52.4 | 76.5 |
| +ScoreHMR | ProHMR | EFT | 51.3 | 76.4 |
| +ScoreHMR | PARE | SPIN | 52.4 | 76.6 |
| +ScoreHMR | PARE | EFT | 51.1 | 76.6 |

Comparison with Optimization Methods

The ScoreHMR was also compared with model fitting baselines that were trained to optimize starting from the canonical pose and shape (i.e., LGD, LFMM) as well as with baselines that can use the parameters from a regression network as a starting point (i.e., SMPLify, ProHMR-fitting). SMPLify (single-stage implementation) and ProMRfitting were benchmarked starting from the predictions of the ProHMR's regression network and those of HMR 2.0. Results are reported below in Table 2. Performing SMPLify on top of regression increases the 3D pose errors, while ProHMR-fitting fails to improve the performance of HMR 2.0. Iterative refinement with ScoreHMR reduces the 3D pose errors in all cases, and ScoreHMR-b outperforms all baselines.

TABLE 2
Evaluation of different model fitting methods. The fitting algorithms
are initialized by the corresponding regression results, except
LGD and LFMM. All numbers are PAMPJPE in mm. Parenthesis denotes
the number of body joints used to compute PA-MPJPE.

| | 3DPW (14) | EMDB 1 (24) |
|---|---|---|
| LGD | 55.9 | 81.1 |
| LFMM | 52.2 | — |
| ProHMR | 59.8 | 86.1 |
| +SMPLify | 60.9 | 84.6 |
| +fitting | 55.1 | 79.8 |
| +ScoreHMR-a | 55.7 | 77.8 |
| +ScoreHMR-b | 54.7 | 77.1 |
| HMR 2.0 | 54.3 | 78.7 |
| +SMPLify | 60.1 | 83.5 |
| +fitting | 55.1 | 80.1 |
| +ScoreHMR-a | 52.4 | 76.5 |
| +ScoreHMR-b | 51.1 | 76.6 |

### Multi-View Refinement

The capability of ScoreHMR was also evaluated at refining the per-view regression estimates when several uncalibrated views of the same person are available. For this task, guidance was used with the cross-view consistency loss [symbol] _{MV} in Eq. (13). This approach was tested on the Human3.6M and the Mannequin Challenge (some YouTube videos were missing) datasets, reporting MPJPE and PA-MPJPE, and compared with the individual per-view regression predictions as well as with an optimization-based method. Results are shown in Table 3. Results from Table 3 show that both ScoreHMR and ProHMR-fitting improve the per-frame predictions, but the ScoreHMR approach consistently leads to lower MPJPE errors. This happens because refining the body poses at a given noise level also influences the global orientation in the next noise level of the diffusion model (e.g., the diffusion model 335), as the model (e.g., the machine learning model 325) captures the joint distribution of SMPL poses θ. This is not possible with ProHMR-fitting, since only the body poses are updated during the optimization process. Notably, the runtime of ScoreHMR (e.g., 1.5 minutes for the entire Mannequin Challenge dataset, which contains 20K frames) is improved over other approaches.

TABLE 3
Evaluation of multi-view refinement. Comparing ScoreHMR
approach with the single-view 3D reconstruction and an
optimization-based method. Parenthesis denotes the number
of body joints used to compute MPJPE and PA-MPJPE.

| | H36M (14) | | Mannequin (17) | |
|---|---|---|---|---|
| | MPJPE ↓ | PA-MPJPE ↓ | MPJPE ↓ | PA-MPJPE ↓ |
| ProHMR | 65.1 | 43.7 | 165.3 | 86.8 |
| +fitting | 59.6 | 34.5 | 162.6 | 80.2 |
| +ScoreHMR-a | 55.8 | 34.1 | 162.0 | 81.1 |
| +ScoreHMR-b | 51.9 | 34.2 | 157.7 | 80.2 |
| HMR 2.0 | 52.8 | 35.6 | 156.0 | 90.1 |
| +fitting | 52.6 | 32.9 | 155.5 | 79.4 |
| +ScoreHMR-a | 47.9 | 28.4 | 151.0 | 79.3 |
| +ScoreHMR-b | 44.7 | 29.0 | 148.3 | 79.1 |

ScoreHMR was also evaluated at refining the single frame regression estimates in a video sequence with 2D keypoint detections. In this setting, guidance was used with [symbol] ᵣₑₚᵣ and [symbol] ₜₑₘₚ terms. The reported acceleration error (mm/s²) is provided herein, which was computed as the difference in acceleration between the ground-truth and predicted 3D joints. All SMPL body joints are used for computing this error in EMDB 1, in contrast to the evaluation that uses specific joints for some temporal metrics (e.g., Jitter).

This approach was compared with the temporal mesh optimization baselines (VIBE-opt, ProHMR-fitting). VIBE-opt was initialized by the temporal mesh regression result of VIBE. ProHMR-fitting was run with the default hyperparameters adding a smoothness regularization term. Results are reported in Table 4. This approach consistently outperformed all baselines across all datasets and metrics. Notably, ScoreHMR significantly enhanced temporal consistency compared to other approaches, resulting in a relative improvement of 21.3% (3DPW) and 40.5% (EMDB 1) in acceleration error compared to ProHMR-fitting, when both methods start from the monocular regression estimate of HMR 2.0. ScoreHMR also exhibited runtime efficiency as compared to other approaches (e.g., requiring only 14 minutes for the entire 3DPW test set, which contains 35K frames).

TABLE 4
Evaluation of human motion refinement. Comparing different
model fitting algorithms and ScoreHMR in a temporal
setting. Parenthesis denotes the number of body joints
used to compute PA-MPJPE and Acc Err.

| | 3DPW (14) | | EMDB 1 (24) | |
|---|---|---|---|---|
| | PA-MPJPE ↓ | Acc Err ↓ | PA-MPJPE ↓ | Acc Err↓ |
| Vibe | 56.7 | 31.5 | 85.7 | 43.8 |
| Vibe-opt | 63.9 | 42.1 | 83.6 | 41.4 |
| ProHMR | 59.8 | 25.0 | 86.1 | 37.7 |
| +fitting | 54.5 | 14.0 | 77.9 | 18.4 |
| +ScoreHMR-a | 54.9 | 11.4 | 76.5 | 12.8 |
| +ScoreHMR-b | 53.9 | 11.2 | 75.7 | 12.1 |
| HMR 2.0 | 54.3 | 17.3 | 78.7 | 23.7 |
| +fitting | 53.8 | 14.1 | 76.2 | 20.0 |
| +ScoreHMR-a | 51.7 | 10.7 | 75.1 | 11.9 |
| +ScoreHMR-b | 50.5 | 11.1 | 75.3 | 11.9 |

### Qualitative Results

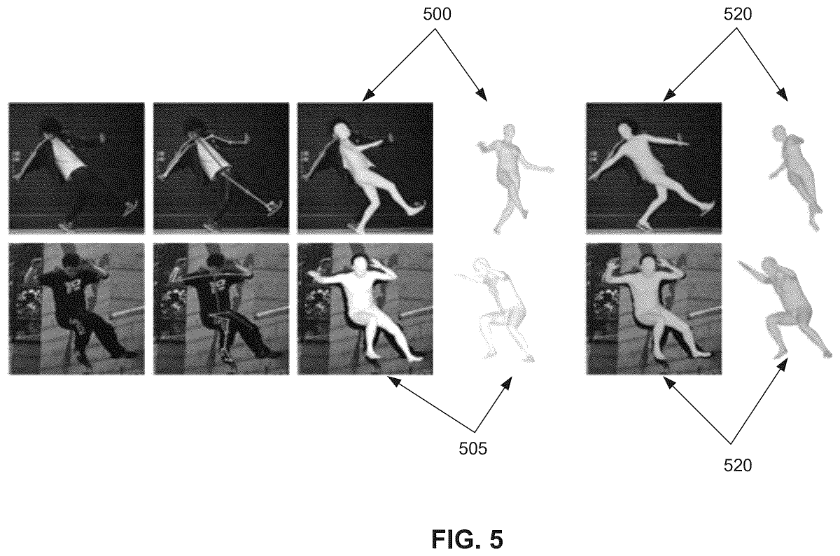

Qualitative results are shown in body model fitting on top of ProHMR and HMR 2.0 regression in FIG. 5. In FIG. 5, the pink models 500 represent regression performed with ProHMR, the white models 505 represent regression performed with HMR 2.0, and the green models 520 represent regression performed with the ScoreHMR, as described herein (e.g., machine learning model 325). As illustrated in FIG. 5, the ScoreHMR effectively aligns the body model with the detected keypoints even when the initial regression estimate is inaccurate (e.g., pink models 500 in the first row).

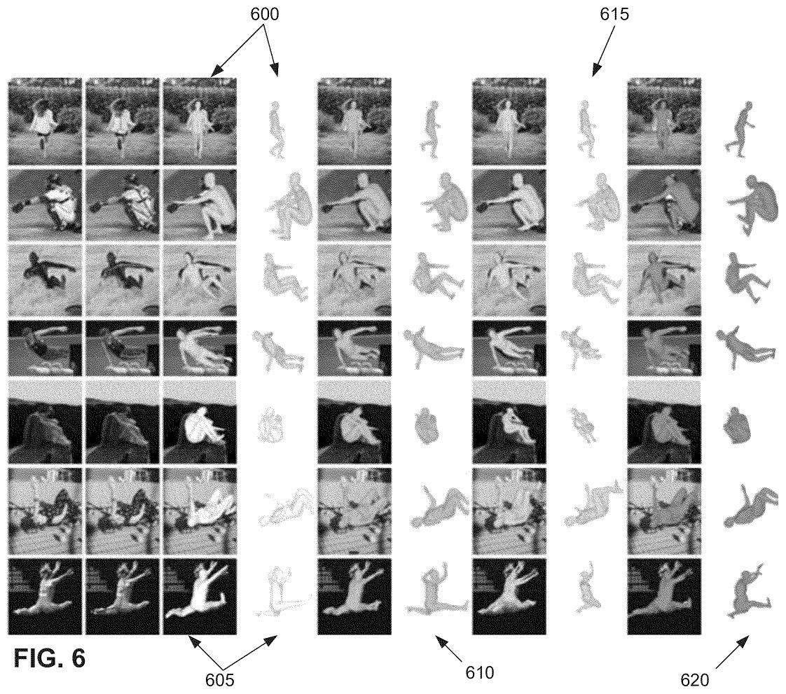

In addition, FIG. 6 illustrates example qualitative evaluations of body model fitting results where ScoreHMR, as described herein, is compared with SMPLify and ProHMR-fitting. In FIG. 6, the pink models 600 represent fitting results using regression (ProHMR), the white models 605 represent fitting results using regression (HMR 2.0), the green models 610 represent fitting results using regression with ScoreHMR, as described herein, (e.g., machine learning model 325), the blue models 615 represent fitting results using regression with ProHMR-fitting, and the grey models 620 represent fitting results using regression with SMPLify. As illustrated in FIG. 6, the regression performed with ScoreHMR achieves more faithful reconstructions than the baselines. This is more evident in challenging poses (e.g., example in last row) of FIG. 6. Also, as illustrated in the example in the second row, SMPLify (grey models 620) encounters challenges with inaccurate keypoint detections, and, as illustrated in the example in the third row including occlusion, ProHMR-fitting (blue models 615) faces difficulties when there is ambiguity in the image evidence. A potential cause for this issue may be the mode supervision used during ProHMR training, which leads to capturing a less diverse pose distribution.

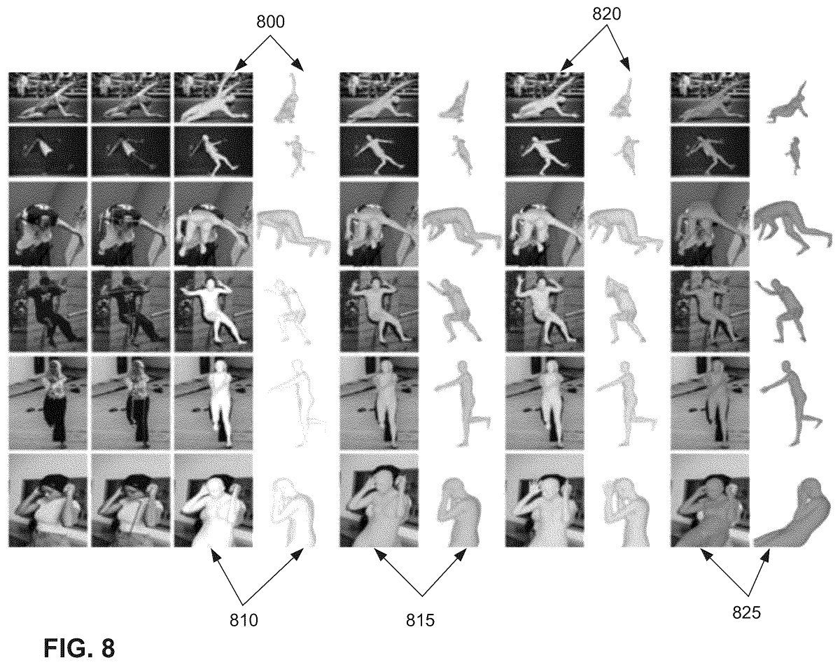

FIG. 8 illustrates additional model fitting results. In FIG. 8, the model fitting algorithms were initialized with regression from ProHMR (see pink models 800) or HMR 2.0b (see white models 810). The green models 815 represent fitting results using the ScoreHMR, as descried herein, whereas the blue models 820 represent fitting results using ProHMR-fitting and the grey models 825 represent fitting results using SMPLify. Again, as illustrated in FIG. 8, the ScoreHMR, as described herein, achieves more faithful reconstructions than the baselines. For example, this improvement in reconstructions can be seen in the case of missing keypoint detections (e.g., see example with truncation in last row), where the SMPLify results in body orientation errors (see grey models 825).

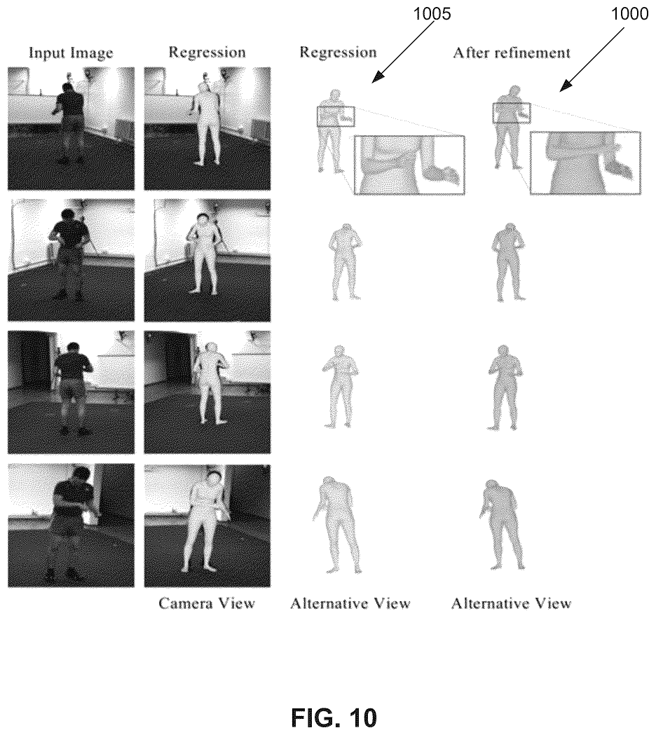

FIG. 10 illustrates an example of multi-view refinement. In FIG. 10, the effectiveness consolidating information from multiple views using Score HMR (see green models 1000) to improve the 3D pose of a human is illustrated. For example, refinement with multiple views fixes the 3D pose of the right hand, which is self-occluded in the first view (see example in first row). In other words, the initial view (first row of FIG. 10) presents challenges with occluded hands, resulting in inaccurate pose estimate for the hands in the regression-only models (see pink models 1005 in FIG. 10). Thus, multiple view fusion with the ScoreHMR results in a more accurate estimation of the true pose.

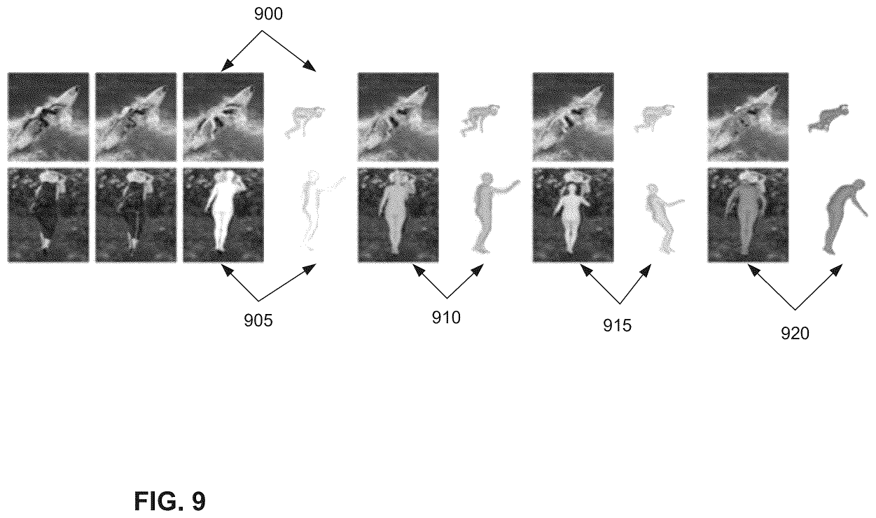

FIG. 9 illustrates examples of failure cases of model fitting. In FIG. 9, the pink models 900 represent ProHMR regression, the white models 905 represent HMR 2.0b regression, the green models 910 represent regression with ScoreHMR, as described herein, (machine learning model 325), the blue models 915 represent regression with ProHMR-fitting, and the grey models 920 represent regression with SMPLify. While all methods encounter challenges when incorrect keypoints are detected, the image-conditioned diffusion model used with ScoreHMR keeps the 3D pose aligned with the available image evidence whereas the optimization-based methods fail in those aspects.

### Ablations

This section provides an ablation study of the two components of score guidance. The ablation study was performed on the 3DPW test set in the model fitting setting, starting from the regression estimate of HMR 2.0b with 54.3 PAMPJPE. In Table 5, for example the default setting for the noise level τ is indicated with an asterisk *. All other components are set to their default values during each component's individual ablation.

### Noise Level τ

The Table 5 below shows the PA-MPJPE error varying τ. As illustrated in the below Table 5, ScoreHMR may work better for small noise levels t. The one-step denoised result \hat{x}₀(xₜ) used to compute the guidance loss (Eq. (10) may also be more accurate for small values of tϵ[0, τ].

TABLE 5
Ablations Study - Noise Level. ScoreHMR is initialized
by the corresponding regression results. All numbers
are PA-MPJPE in mm. Parenthesis denotes the number
of body joints used to compute PA-MPJPE.

| τ | 50* | 100 | 200 | 300 |
|---|---|---|---|---|
| HMR 2.0b + ScoreHMR | 51.1 | 52.3 | 54.3 | 54.5 |

### DDIM Step Size Δt

The Table 6 below shows the PA-MPJPE error varying the DDIM step size Δt. In Table 6, for example the default setting for the DDIM step size Δt is indicated with an asterisk *. Even though larger DDIM step sizes result in lower PA-MPJPE in 3DPW, ScoreHMR with a small step size is more robust and performs better qualitatively especially for challenging and unusual poses. A similar observation is made, where HMR 2.0b has a higher PA-MPJPE error than HMR 2.0a but performs better in practice.

TABLE 6
Ablations Study - DDIM Step Sizw. ScoreHMR is initialized
by the corresponding regression results. All numbers
are PA-MPJPE in mm. Parenthesis denotes the number
of body joints used to compute PA-MPJPE.

| Δt | 2* | 4 | 6 | 8 | 10 | 12 |
|---|---|---|---|---|---|---|
| HMR 2.0b + ScoreHMR | 51.1 | 49.6 | 48.8 | 48.4 | 48.2 | 48.4 |

### Evaluation Metrics

Depending on the setting, the MPJPE, PA-MPJPE and Acc Err metrics were evaluated following standard practices in the literature. The Mean Per Joint Position Error (MPJPE) computes the Euclidean error between the predicted and ground-truth 3D joints, after aligning them at the pelvis. The PA-MPJPE computes the same error after aligning the predicting the ground-truth 3D joints with Procrustes alignment. Both metrics are used for per-frame 3D human pose evaluation. The acceleration error (Acc Err) is a temporal metric that measures the average difference between ground truth 3D acceleration and predicted 3D acceleration of joints in mm/s².

Refinement from HMR 2.0a

The Table 7 below shows the PA-MPJPE of model fitting on 3DPW test set, starting from HMR 2.0a regression. As illustrated in the Table 7, ScoreHMR quantitatively improves the performance of HMR 2.0a (by 4.5%).

TABLE 7
Evaluation of Refinement from HMR 2.0a. ScoreHMR is
initialized by the corresponding regression results.
All numbers are PA-MPJPE in mm. Parenthesis denotes
the number of body joints used to compute PA-MPJPE.

| HMR 2.0a | +ScoreHMR | +ProHMR-fitting | +SMPLify |
|---|---|---|---|
| 44.5 | 42.5 | 54.9 | 52.5 |

### Example Flowchart Implementing ScoreHMR

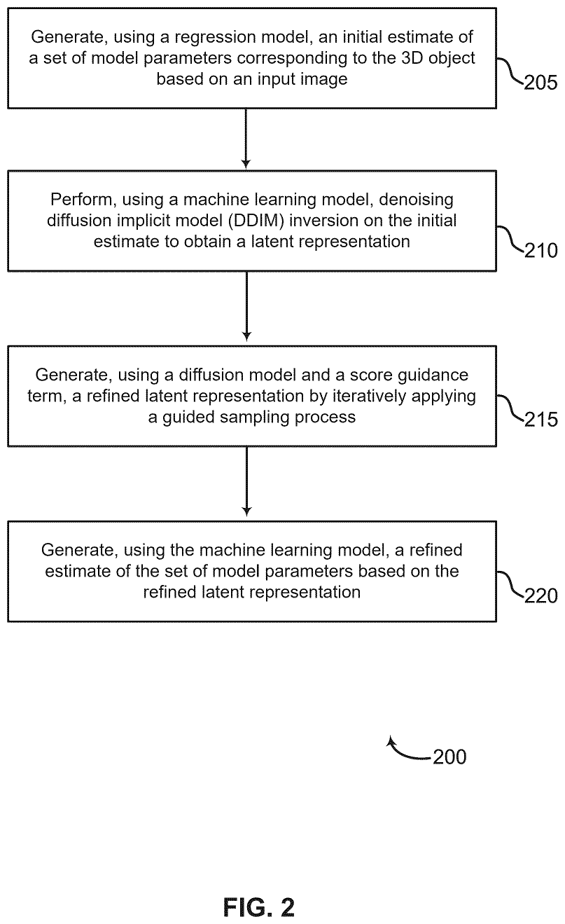

FIG. 2 is a flowchart illustrating a computer-implemented method 100 for estimating a three-dimensional (3D) object with a two-dimensional (2D) input image. The method 100 may be performed via a computer system, such as the real-time data analytics apparatus 300 in FIG. 1 to implement the functionality of the system described herein.

At operation 105, the method 100 includes generating, using a regression model, an initial estimate of a set of model parameters corresponding to the 3D object based on an input image. In some examples the apparatus 300 inputs an image into the regression model 330, and the regression model 330 provides a set of model parameters, for example, a SMPL estimate, corresponding to the image. In some examples, the CNN backbone 340 extracts salient features from the image, which the regression model 330 uses to generate the set of model parameters.

At operation 110, the apparatus 300 performs, using a machine learning model 325, denoising diffusion implicit model (DDIM) inversion on the initial estimate to obtain a latent representation. In some examples, the machine learning model 325 performs the DDIM inversion process and channels the initial estimate to a latent space of the diffusion model 335. In those examples, the machine learning model 325 maps the initial estimate to a latent space of the diffusion model at a predetermined noise level, using a deterministic inversion process.

At operation 115, the apparatus 300 generates, using a diffusion model and a score guidance term, a refined latent representation by iteratively applying a guided sampling process. In some examples, the machine learning model 325 refines the latent representation through an iterative process that combines a pre-trained diffusion model 335 with task-specific guidance. At each iteration, a modified noise prediction is calculated by augmenting a noise prediction of the diffusion model 335 with a score guidance term. In some examples, the score guidance term is based on observed 2D keypoints of a single image, additional views of the same object, and/or additional frames of a video including the same object.

At operation 120, the apparatus 300 generates, using the machine learning model 325, a refined estimate of the set of model parameters based on the refined latent representation. In some examples, the diffusion model 335 iteratively refines, by generating refined object model parameters that more accurately represent the 3D object based on the image, the mapped initial regression estimate in a DDIM guided sampling loop until the human body model aligns with an available observation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Various features, advantages, and examples are set forth in the following claims.

What is claimed is:

1. A computer-implemented method for estimating a three-dimensional (3D) object, comprising:
receiving an initial estimate of a set of model parameters corresponding to the 3D object based on an input image, the initial estimate generated using a regression model;
performing, using a machine learning model, denoising diffusion implicit model (DDIM) inversion on the initial estimate to obtain a latent representation;
generating, using a diffusion model and a score guidance term, a refined latent representation by iteratively applying a guided sampling process; and
generating, using the machine learning model, a refined estimate of the set of model parameters based on the refined latent representation.

2. The method of claim 1, further comprising generating the initial estimate using the regression model, wherein generating the initial estimate comprises:
extracting image features from the input image using a convolutional neural network (CNN) backbone (340); and
predicting human body model parameters using the regression model, based on the extracted image features.

3. The method of claim 1, wherein performing DDIM inversion comprises:
mapping the initial estimate to a latent space of the diffusion model at a predetermined noise level, using a deterministic inversion process.

4. The method of claim 1, wherein generating the refined latent representation comprises:
calculating a modified noise prediction at each iteration, by combining a noise prediction from the diffusion model with the score guidance term; and
updating the latent representation using the modified noise prediction, based on DDIM sampling equations.

5. The method of claim 4, wherein the score guidance term is based on keypoints from the input image.

6. The method of claim 4, wherein the score guidance term is based on additional views, wherein the additional views and the input image are different views of the 3D object.

7. The method of claim 4, wherein the score guidance term is based on additional frames, wherein the additional frames and the input image are different frames from a video.

8. An apparatus for estimating a three-dimensional (3D) object, comprising:
an electronic processor;
a memory storing instructions executable by the electronic processor; and
a machine learning model comprising parameters stored in the memory and trained to, through execution of the instructions by the electronic processor:
receive an initial estimate of a set of model parameters corresponding to the 3D object, based on an input image, the initial estimate generated using a regression model;
perform denoising diffusion implicit model (DDIM) inversion on the initial estimate to obtain a latent representation;
generate, using a diffusion model and a score guidance term, a refined latent representation by iteratively applying a guided sampling process; and
generate a refined estimate of the set of model parameters based on the refined latent representation.

9. The apparatus of claim 8, further comprising:
a convolutional neural network (CNN) backbone trained to extract image features from a 2D image; and
the regression model trained to predict human body model parameters based on the extracted image features.

10. The apparatus of claim 8, wherein the machine learning model is further trained to:
map the initial estimate to a latent space of the diffusion model at a predetermined noise level, using a deterministic inversion process.

11. The apparatus of claim 8, wherein the machine learning model is further trained to:
calculate a modified noise prediction at each iteration, by combining a noise prediction from the diffusion model with the score guidance term; and
update the latent representation using the modified noise prediction, based on DDIM sampling equations.

12. The apparatus of claim 11, wherein the score guidance term is based on detected 2D keypoints from the input image.

13. The apparatus of claim 8, wherein the score guidance term is based on additional views, and wherein the additional views and the input image are different views of the 3D object.

14. The apparatus of claim 8, wherein the score guidance term is based on additional frames, and wherein the additional frames and the input image are different frames from a video.

15. A computer-implemented method for training a diffusion model for three-dimensional (3D) object estimate, comprising:
obtaining a dataset of images and corresponding human body model parameters;
predicting a noise using the diffusion model based on noisy human body model parameters and image features;
computing a denoising loss based on a difference between a predicted noise and ground-truth noise added during a forward diffusion process; and
updating parameters of the diffusion model based on the denoising loss.

16. The method of claim 15, further comprising:
extracting image features from the images using a convolutional neural network (CNN) backbone;
computing a feature extraction loss based on a difference between the extracted image features and ground-truth body model parameters; and
updating parameters of the CNN backbone based on the feature extraction loss.

17. The method of claim 15, further comprising:
predicting 2D keypoints from the human body model parameters;
computing a reprojection loss based on a difference between the predicted 2D keypoints and ground-truth 2D keypoints; and
updating parameters of the diffusion model based on the reprojection loss.

18. The method of claim 15, further comprising:
predicting pose parameters for multiple views using the diffusion model;
computing a multi-view consistency loss based on differences between pose parameters predicted for different views of a same object; and
updating parameters of the diffusion model based on the multi-view consistency loss.

19. The method of claim 15, further comprising:
predicting pose parameters for consecutive frames in a video;
computing a temporal consistency loss based on differences between pose parameters of the consecutive frames; and
updating parameters of the diffusion model based on the temporal consistency loss.

20. The method of claim 15, further comprising:
predicting body shape parameters using the diffusion model;
computing a shape loss based on a difference between the predicted body shape parameters and ground-truth body shape parameters; and
updating parameters of the diffusion model based on the shape loss.
